(19) United States
(12) Patent Application Publication
(10) Pub. No.: US 2017/0222491 A1
(43) Pub. Date: Aug. 3, 2017

(54) SYSTEM AND METHOD FOR ADJUSTING AN ANTENNA RESPONSE IN A WIRELESS POWER RECEIVER

(71) Applicant: QUALCOMM Incorporated, San Diego, CA (US)

(72) Inventors: William Henry Von Novak, III, San Diego, CA (US); Seong Heon Jeong, San Diego, CA (US)

(21) Appl. No.: 15/092,708

(22) Filed: Apr. 7, 2016

Related U.S. Application Data
(60) Provisional application No. 62/290,537, filed on Feb. 3, 2016.

(51) Int. Cl. H02J 50/90; H02J 50/12

(52) U.S. Cl. CPC H02J 50/90; H02J 50/12

(57) ABSTRACT

A wireless power receiver includes a first receive coil configured to generate electrical current in response to a first external magnetic field generated by a transmit coil, and a second receive coil configured to generate electrical current in response to a second magnetic field generated by eddy currents induced in a metal portion of the wireless power receiver in response to the first external magnetic field.

### RELATED APPLICATIONS

This application claims the benefit of U.S. Provisional Patent Application No. 62/290,537, entitled “System And Method For Adjusting An Antenna Response In A Wireless Power Receiver,” filed Feb. 3, 2016, the contents of which are hereby incorporated by reference in their entirety.

### FIELD

The present disclosure relates generally to wireless power. More specifically, the disclosure is directed to adjusting an antenna response in a wireless power receiver.

### BACKGROUND

An increasing number and variety of electronic devices are powered via rechargeable batteries. Such devices include mobile phones, portable music players, laptop computers, tablet computers, computer peripheral devices, communication devices (e.g., Bluetooth devices), digital cameras, hearing aids, and the like. While battery technology has improved, battery-powered electronic devices increasingly require and consume greater amounts of power, thereby often requiring recharging. Rechargeable devices are often charged via wired connections that require cables or other similar connectors that are physically connected to a power supply. Cables and similar connectors may sometimes be inconvenient or cumbersome and have other drawbacks. Wireless charging systems that are capable of transferring power in free space to be used to charge rechargeable electronic devices may overcome some of the deficiencies of wired charging solutions. As such, wireless charging systems and methods that efficiently and safely transfer power for charging rechargeable electronic devices are desirable. To efficiently and safely transfer power for charging rechargeable electronic devices, it is desirable that various sizes, shapes, and form factors of a wireless power receiver can obtain sufficient charge from a wireless power transmitter.

### SUMMARY

Various implementations of systems, methods and devices within the scope of the appended claims each have several aspects, no single one of which is solely responsible for the desirable attributes described herein. Without limiting the scope of the appended claims, some prominent features are described herein.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

One aspect of the disclosure provides a wireless power receiver including a first receive coil configured to generate electrical current in response to a first external magnetic field generated by a transmit coil, and a second receive coil configured to generate electrical current in response to a second magnetic field generated by eddy currents induced in a metal portion of the wireless power receiver in response to the first external magnetic field.

Another aspect of the disclosure provides a method for adjusting a level of magnetic coupling in a wireless power receiver including generating a first electrical current in a first receive coil in response to a first external magnetic field generated by a transmit coil, and generating a second electrical current in a second receive coil in response to a second magnetic field generated by eddy currents induced in a metal portion of a wireless power receiver in response to the first external magnetic field.

Another aspect of the disclosure provides a device for adjusting a level of magnetic coupling in a wireless power receiver including first means for generating electrical current in response to a first external magnetic field generated by a transmit coil, and second means for generating electrical current in response to a second magnetic field generated by eddy currents induced in a metal portion of the wireless power receiver in response to the first external magnetic field.

Another aspect of the disclosure provides a wireless power receiver apparatus including a first receive coil, a receive circuit electrically coupled to the first receive coil and configured to power or charge a load in response to receiving and controlling current generated in the first receive coil in the presence of a first external magnetic field, and a second receive coil positioned in a region towards an outer portion of the apparatus where one or more eddy currents are configured to be generated in one or more metal portions of the apparatus that are outside of an an area defined by the first receive coil.

### BRIEF DESCRIPTION OF THE DRAWINGS

In the figures, like reference numerals refer to like parts throughout the various views unless otherwise indicated. For reference numerals with letter character designations such as “102a” or “102b”, the letter character designations may differentiate two like parts or elements present in the same figure. Letter character designations for reference numerals may be omitted when it is intended that a reference numeral encompass all parts having the same reference numeral in all figures.

FIG. 1 is a functional block diagram of an exemplary wireless power transfer system, in accordance with exemplary embodiments of the invention.

FIG. 2 is a functional block diagram of exemplary components that may be used in the wireless power transfer system of FIG. 1, in accordance with various exemplary embodiments of the invention.

FIG. 3 is a schematic diagram of a portion of transmit circuitry or receive circuitry of FIG. 2 including a transmit or receive antenna, in accordance with exemplary embodiments of the invention.

FIG. 4 is a functional block diagram of a transmitter that may be used in the wireless power transfer system of FIG. 1, in accordance with exemplary embodiments of the invention.

FIG. 5 is a functional block diagram of a receiver that may be used in the wireless power transfer system of FIG. 1, in accordance with exemplary embodiments of the invention.

FIG. 6 is a schematic diagram of a portion of transmit circuitry that may be used in the transmit circuitry of FIG. 4.

FIG. 7 is a schematic diagram showing an exemplary receiver located on a wireless charging surface.

FIG. 8 is a schematic diagram showing an exemplary receiver located on a wireless charging surface.

FIG. 9 is a schematic diagram showing an exemplary embodiment of a receiver with a receive antenna.

FIG. 10 is a schematic diagram showing an exemplary embodiment of a receiver with a receive antenna.

FIG. 11 is a schematic diagram showing an exemplary embodiment of a receiver with a receive antenna.

FIG. 12 is a schematic diagram showing an exemplary embodiment of a receiver with a receive antenna.

FIG. 13 is a schematic diagram illustrating coupling mechanisms modeled as transformer structures as a result of the direct coupling shown in FIG. 10 and FIG. 11.

FIG. 14 is a schematic diagram illustrating coupling mechanisms modeled as transformer structures as a result of the transformer coupling shown in FIG. 12.

FIG. 15 is a schematic diagram illustrating an exemplary embodiment of an inductive coupling between a primary receive antenna and a secondary receive antenna.

FIG. 16 is a schematic diagram illustrating an exemplary embodiment of an inductive coupling between a primary receive antenna and a secondary receive antenna.

FIG. 17 is a schematic diagram illustrating an exemplary embodiment of an inductive coupling between a primary receive antenna and a secondary receive antenna.

FIG. 18 is a schematic diagram illustrating an exemplary embodiment of an alternative exemplary embodiment of a receiver with a receive antenna.

FIG. 19 is a is a schematic diagram showing an alternative exemplary embodiment of a receiver configured to reduce eddy current.

FIG. 20 is a flowchart illustrating an exemplary embodiment of a method for adjusting a response of a primary receive antenna.

FIG. 21 is a functional block diagram of an apparatus for for adjusting a response of a primary receive antenna.

The various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DETAILED DESCRIPTION

The detailed description set forth below in connection with the appended drawings is intended as a description of exemplary embodiments of the invention and is not intended to represent the only embodiments in which the invention may be practiced. The term “exemplary” used throughout this description means “serving as an example, instance, or illustration,” and should not necessarily be construed as preferred or advantageous over other exemplary embodiments. The detailed description includes specific details for the purpose of providing a thorough understanding of the exemplary embodiments of the invention. In some instances, some devices are shown in block diagram form.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed.

As used in this description, the terms “component,” “database,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

Wirelessly transferring power may refer to transferring any form of energy associated with electric fields, magnetic fields, electromagnetic fields, or otherwise from a transmitter to a receiver without the use of physical electrical conductors (e.g., power may be transferred through free space). The power output into a wireless field (e.g., a magnetic field) may be received, captured by, or coupled by a “receiving antenna” to achieve power transfer.

It is desirable to have the ability to efficiently and safely transfer power for wirelessly charging rechargeable electronic devices of various sizes, shapes, and form factors. Some wireless receiver devices have attributes that may make wireless charging difficult. For example, a large receiver containing metal plate, or a receiver having a small receive antenna located near the center of a metal plate in the receiver may give rise to inconsistencies in the wireless charging field that is used to transfer power. Such an inconsistency may sometimes be referred to as a “hole” or a “peak” in the wireless charging field, and the resultant magnetic coupling will be either higher or lower than expected due to eddy current effects from the metal plate in the receiver. This leads to a wide variation in magnetic coupling and power transfer, which complicates receiver antenna design.

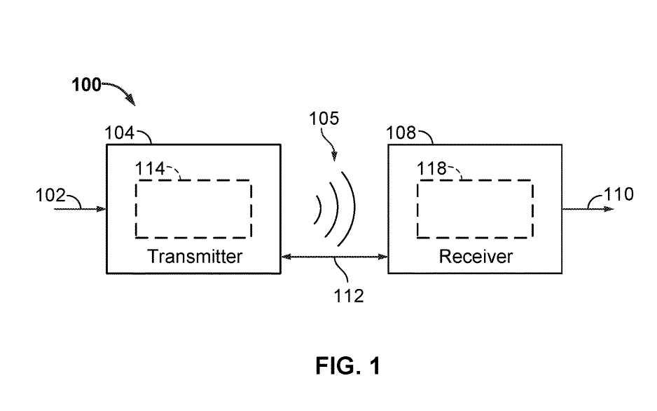

FIG. 1 is a functional block diagram of an exemplary wireless power transfer system 100, in accordance with exemplary embodiments of the invention. Input power 102 may be provided to a transmitter 104 from a power source (not shown) for generating a field 105 (e.g., magnetic or species of electromagnetic) for providing energy transfer. A receiver 108 may couple to the field 105 and generate output power 110 for storing or consumption by a device (not shown) coupled to the output power 110. Both the transmitter 104 and the receiver 108 are separated by a distance 112. In one exemplary embodiment, transmitter 104 and receiver 108 are configured according to a mutual resonant relationship. When the resonant frequency of receiver 108 and the resonant frequency of transmitter 104 are substantially the same or very close, transmission losses between the transmitter 104 and the receiver 108 are reduced. As such, wireless power transfer may be provided over larger distance in contrast to purely inductive solutions that may require large coils to be very close (e.g., millimeters). Resonant inductive coupling techniques may thus allow for improved efficiency and power transfer over various distances and with a variety of inductive coil configurations.

The receiver 108 may receive power when the receiver 108 is located in an energy field 105 produced by the transmitter 104. The field 105 corresponds to a region where energy output by the transmitter 104 may be captured by a receiver 108. The transmitter 104 may include a transmit antenna 114 (that may also be referred to herein as a coil) for outputting an energy transmission. The receiver 108 further includes a receive antenna 118 (that may also be referred to herein as a coil) for receiving or capturing energy from the energy transmission. In some cases, the field 105 may correspond to the “near-field” of the transmitter 104. The near-field may correspond to a region in which there are strong reactive fields resulting from the currents and charges in the transmit antenna 114 that minimally radiate power away from the transmit antenna 114. In some cases the near-field may correspond to a region that is within about one wavelength (or a fraction thereof) of the transmit antenna 114. When positioned within the field 105, a “coupling mode” may be developed between the transmit antenna 114 and the receive antenna 118. The area around the transmit and receive antennas 114 and 118 where this coupling may occur may be referred to as a coupling-mode region.

In accordance with the above therefore, in accordance with more particular embodiments, the transmitter 104 may be configured to output a time varying magnetic field 105 with a frequency corresponding to the resonant frequency of the transmit antenna 114. When the receiver is within the field 105, the time varying magnetic field 105 may induce a voltage in the receive antenna 118 that causes an electrical current to flow through the receive antenna 118. As described above, if the receive antenna 118 is configured to be resonant at the frequency of the transmit antenna 114, energy may be efficiently transferred. The AC signal induced in the receive antenna 118 may be rectified to produce a DC signal that may be provided to charge or to power a load.

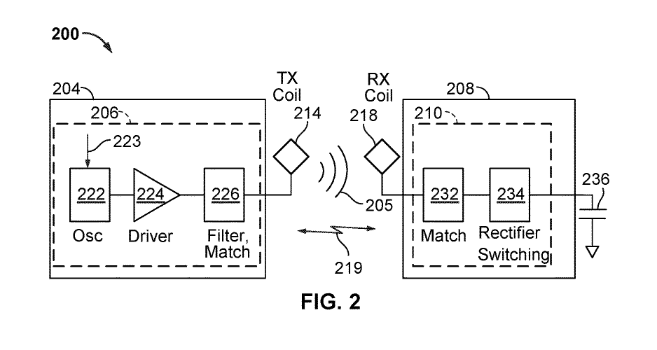

FIG. 2 is a functional block diagram 200 of exemplary components that may be used in the wireless power transfer system 100 of FIG. 1, in accordance with various exemplary embodiments of the invention. The transmitter 204 may include transmit circuitry 206 that may include an oscillator 222, a driver circuit 224, and a filter and matching circuit 226. The oscillator 222 may be configured to generate a signal at a desired frequency, such as 468.75 KHz, 6.78 MHz or 13.56 MHz, that may be adjusted in response to a frequency control signal 223. The oscillator signal may be provided to a driver circuit 224 configured to drive the transmit antenna 214 at, for example, a resonant frequency of the transmit antenna 214. The driver circuit 224 may be a switching amplifier configured to receive a square wave from the oscillator 222 and output a sine wave. For example, the driver circuit 224 may be a class E amplifier. A filter and matching circuit 226 may be also included to filter out harmonics or other unwanted frequencies and match the impedance of the transmitter 204 to the transmit antenna 214. As a result of driving the transmit antenna 214, the transmitter 204 may wirelessly output power at a level sufficient for charging or powering an electronic device. As one example, the power provided may be for example on the order of 300 milliWatts to 5 Watts or 5 Watts to 40 Watts to power or charge different devices with different power requirements. Higher or lower power levels may also be provided.

The receiver 208 may include receive circuitry 210 that may include a matching circuit 232 and a rectifier and switching circuit 234 to generate a DC power output from an AC power input to charge a battery 236 as shown in FIG. 2 or to power a device (not shown) coupled to the receiver 108. The matching circuit 232 may be included to match the impedance of the receive circuitry 210 to the receive antenna 218. The receiver 208 and transmitter 204 may additionally communicate on a separate communication channel 219 (e.g., Bluetooth, zigbee, cellular, etc.). The receiver 208 and transmitter 204 may alternatively communicate via in-band signaling using characteristics of the wireless field 205.

The receiver 208 may initially have a selectively disablable associated load (e.g., battery 236), and may be configured to determine whether an amount of power transmitted by transmitter 204 and received by receiver 208 is appropriate for charging a battery 236. Further, receiver 208 may be configured to enable a load (e.g., battery 236) upon determining that the amount of power is appropriate.

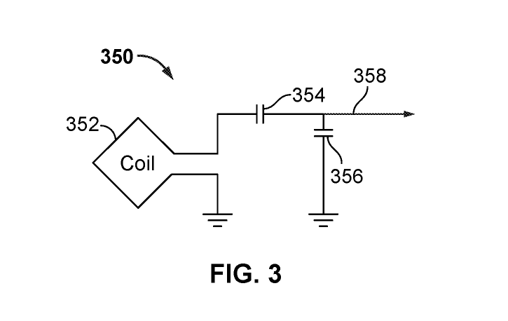

FIG. 3 is a schematic diagram of a portion of transmit circuitry 206 or receive circuitry 210 of FIG. 2 including a transmit or receive antenna 352, in accordance with exemplary embodiments of the invention. As illustrated in FIG. 3, transmit or receive circuitry 350 used in exemplary embodiments including those described below may include an antenna 352. The antenna 352 may also be referred to or be configured as a “loop” antenna 352. The antenna 352 may also be referred to herein or be configured as a “magnetic” antenna or an induction coil. The term “antenna” generally refers to a component that may wirelessly output or receive energy for coupling to another “antenna.” The antenna may also be referred to as a coil of a type that is configured to wirelessly output or receive power. As used herein, an antenna 352 is an example of a “power transfer component” of a type that is configured to wirelessly output and/or receive power. The antenna 352 may be configured to include an air core or a physical core such as a ferrite core (not shown).

The antenna 352 may form a portion of a resonant circuit configured to resonate at a resonant frequency. The resonant frequency of the loop or magnetic antenna 352 is based on the inductance and capacitance. Inductance may be simply the inductance created by the antenna 352, whereas, capacitance may be added to create a resonant structure (e.g., a capacitor may be electrically connected to the antenna 352 in series or in parallel) at a desired resonant frequency. As a non-limiting example, capacitor 354 and capacitor 356 may be added to the transmit or receive circuitry 350 to create a resonant circuit that resonates at a desired frequency of operation. For larger diameter antennas, the size of capacitance needed to sustain resonance may decrease as the diameter or inductance of the loop increases. As the diameter of the antenna increases, the efficient energy transfer area of the near-field may increase. Other resonant circuits formed using other components are also possible. As another non-limiting example, a capacitor (not shown) may be placed in parallel between the two terminals of the antenna 352. For transmit antennas, a signal 358 with a frequency that substantially corresponds to the resonant frequency of the antenna 352 may be an input to the antenna 352. For receive antennas, the signal 358 may be the output that may be rectified and used to power or charge a load.

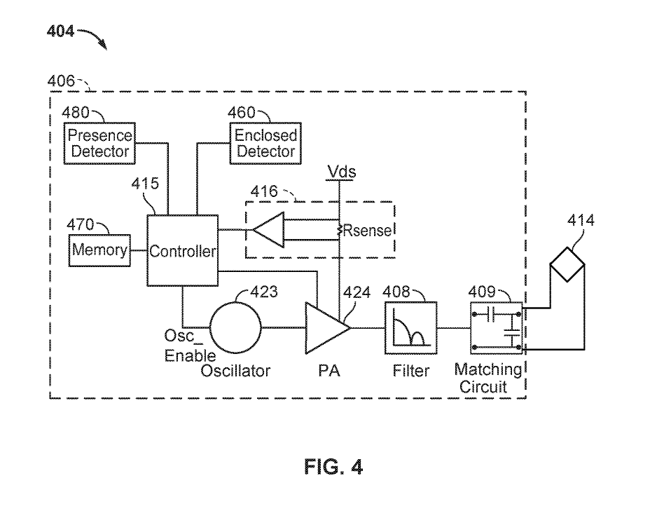

FIG. 4 is a functional block diagram of a transmitter 404 that may be used in the wireless power transfer system of FIG. 1, in accordance with exemplary embodiments of the invention. The transmitter 404 may include transmit circuitry 406 and a transmit antenna 414. The transmit antenna 414 may be the antenna 352 as shown in FIG. 3. The transmit antenna 414 may be configured as the transmit antenna 214 as described above in reference to FIG. 2. In some implementations, the transmit antenna 414 may be a coil (e.g., an induction coil). In some implementations, the transmit antenna 414 may be associated with a larger structure, such as a pad, table, mat, lamp, or other stationary configuration. Transmit circuitry 406 may provide power to the transmit antenna 414 by providing an oscillating signal resulting in generation of energy (e.g., magnetic flux) about the transmit antenna 414. Transmitter 404 may operate at any suitable frequency. By way of example, transmitter 404 may operate at the 6.78 MHz ISM band.

Transmit circuitry 406 may include a fixed impedance matching circuit 409 for matching the impedance of the transmit circuitry 406 (e.g., 50 ohms) to the transmit antenna 414 and a low pass filter (LPF) 408 configured to reduce harmonic emissions to levels to prevent interference with devices and self-jamming of devices coupled to receivers 108 (FIG. 1). Other exemplary embodiments may include different filter topologies, including but not limited to, notch filters that attenuate specific frequencies while passing others and may include an adaptive impedance match, that may be varied based on measurable transmit metrics, such as output power to the transmit antenna 414 or DC current drawn by the transmitter driver circuit 424. Transmit circuitry 406 further includes a driver circuit 424 configured to drive a signal as determined by an oscillator 423. The transmit circuitry 406 may be comprised of discrete devices or circuits, or alternately, may be comprised of an integrated assembly.

Transmit circuitry 406 may further include a controller 415 for selectively enabling the oscillator 423 during transmit phases (or duty cycles) for specific receivers, for adjusting the frequency or phase of the oscillator 423, and for adjusting the output power level for implementing a communication protocol for interacting with neighboring devices through their attached receivers. It is noted that the controller 415 may also be referred to herein as a processor The controller 415 may be coupled to a memory 470. Adjustment of oscillator phase and related circuitry in the transmission path may allow for reduction of out of band emissions, especially when transitioning from one frequency to another.

The transmit circuitry 406 may further include a load sensing circuit 416 for detecting the presence or absence of active receivers in the vicinity of the near-field generated by transmit antenna 414. By way of example, a load sensing circuit 416 monitors the current flowing to the transmitter driver circuit 424, that may be affected by the presence or absence of active receivers in the vicinity of the field generated by transmit antenna 414 as will be further described below. Detection of changes to the loading on the transmitter driver circuit 424 are monitored by controller 415 for use in determining whether to enable the oscillator 423 for transmitting energy and to communicate with an active receiver. As described more fully below, a current measured at the transmitter driver circuit 424 may be used to determine whether an invalid device is positioned within a wireless power transfer region of the transmitter 404.

The transmit antenna 414 may be implemented with a Litz wire or as an antenna strip with the thickness, width and metal type selected to keep resistive losses low.

The transmitter 404 may gather and track information about the whereabouts and status of receiver devices that may be associated with the transmitter 404. Thus, the transmit circuitry 406 may include a presence detector 480, an enclosed detector 460, or a combination thereof, connected to the controller 415 (also referred to as a processor herein). The controller 415 may adjust an amount of power delivered by the transmitter driver circuit 424 in response to presence signals from the presence detector 480 and the enclosed detector 460. The transmitter 404 may receive power through a number of power sources, such as, for example, an AC-DC converter (not shown) to convert AC power present in a building, a DC-DC converter (not shown) to convert a DC power source to a voltage suitable for the transmitter 404, or directly from a DC power source (not shown).

As a non-limiting example, the presence detector 480 may be a motion detector utilized to sense the initial presence of a device to be charged that is inserted into the coverage area of the transmitter 404. After detection, the transmitter 404 may be turned on and the RF power received by the device may be used to toggle a switch on the Rx device in a pre-determined manner, which in turn results in changes to the driving point impedance of the transmitter 404.

As another non-limiting example, the presence detector 480 may be a detector capable of detecting a human, for example, by infrared detection, motion detection, or other suitable means. In some exemplary embodiments, there may be regulations limiting the amount of power that a transmit antenna 414 may transmit at a specific frequency. In some cases, these regulations are meant to protect humans from electromagnetic radiation. However, there may be environments where a transmit antenna 414 is placed in areas not occupied by humans, or occupied infrequently by humans, such as, for example, garages, factory floors, shops, and the like. If these environments are free from humans, it may be permissible to increase the power output of the transmit antenna 414 above the normal power restrictions regulations. In other words, the controller 415 may adjust the power output of the transmit antenna 414 to a regulatory level or lower in response to human presence and adjust the power output of the transmit antenna 414 to a level above the regulatory level when a human is outside a regulatory distance from the wireless charging field of the transmit antenna 414.

As a non-limiting example, the enclosed detector 460 (may also be referred to herein as an enclosed compartment detector or an enclosed space detector) may be a device such as a sense switch for determining when an enclosure is in a closed or open state. When a transmitter is in an enclosure that is in an enclosed state, a power level of the transmitter may be increased.

In exemplary embodiments, a method by which the transmitter 404 does not remain on indefinitely may be used. In this case, the transmitter 404 may be programmed to shut off after a user-determined amount of time. This feature prevents the transmitter 404, notably the transmitter driver circuit 424, from running long after the wireless devices in its perimeter are fully charged. This event may be due to the failure of the circuit to detect the signal sent from either the repeater or the receive antenna 218 that a device is fully charged. To prevent the transmitter 404 from automatically shutting down if another device is placed in its perimeter, the transmitter 404 automatic shut off feature may be activated only after a set period of lack of motion detected in its perimeter. The user may be able to determine the inactivity time interval, and change it as desired. As a non-limiting example, the time interval may be longer than that needed to fully charge a specific type of wireless device under the assumption of the device being initially fully discharged.

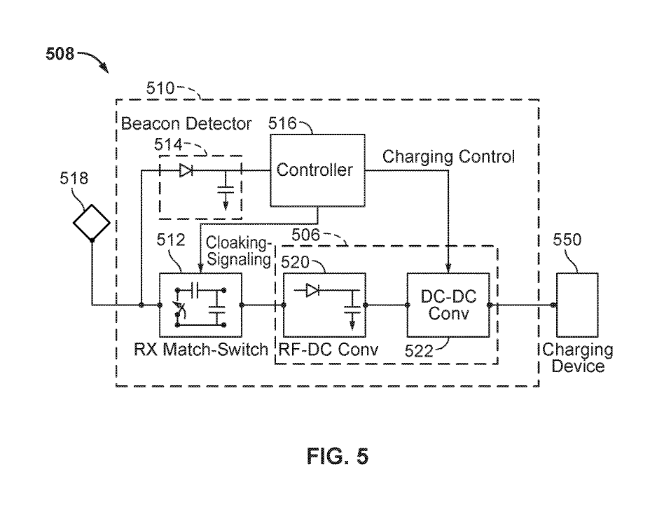

FIG. 5 is a functional block diagram of a receiver 508 that may be used in the wireless power transfer system of FIG. 1, in accordance with exemplary embodiments of the invention. The receiver 508 includes receive circuitry 510 that may include a receive antenna 518. Receiver 508 further couples to device 550 for providing received power thereto. It should be noted that receiver 508 is illustrated as being external to device 550 but may be integrated into device 550. Energy may be propagated wirelessly to receive antenna 518 and then coupled through the rest of the receive circuitry 510 to device 550. By way of example, the charging device may include devices such as mobile phones, portable music players, laptop computers, tablet computers, computer peripheral devices, communication devices (e.g., Bluetooth devices), digital cameras, hearing aids (and other medical devices), wearable devices, and the like.

Receive antenna 518 may be tuned to resonate at the same frequency, or within a specified range of frequencies, as transmit antenna 414 (FIG. 4). Receive antenna 518 may be similarly dimensioned with transmit antenna 414 or may be differently sized based upon the dimensions of the associated device 550. By way of example, device 550 may be a portable electronic device having diametric or length dimension smaller than the diameter or length of transmit antenna 414. In such an example, receive antenna 518 may be implemented as a multi-turn coil in order to reduce the capacitance value of a tuning capacitor (not shown) and increase the receive coil's impedance. By way of example, receive antenna 518 may be placed around the substantial circumference of device 550 in order to maximize the antenna diameter and reduce the number of loop turns (i.e., windings) of the receive antenna 518 and the inter-winding capacitance.

Receive circuitry 510 may provide an impedance match to the receive antenna 518. Receive circuitry 510 includes power conversion circuitry 506 for converting a received RF energy source into charging power for use by the device 550. Power conversion circuitry 506 includes an RF-to-DC converter 520 and may also include a DC-to-DC converter 522. RF-to-DC converter 520 rectifies the RF energy signal received at receive antenna 518 into a non-alternating power with an output voltage. The DC-to-DC converter 522 (or other power regulator) converts the rectified RF energy signal into an energy potential (e.g., voltage) that is compatible with device 550 with an output voltage and output current. Various RF-to-DC converters are contemplated, including partial and full rectifiers, regulators, bridges, doublers, as well as linear and switching converters.

Receive circuitry 510 may further include RX matching and switching circuitry 512 for connecting receive antenna 518 to the power conversion circuitry 506 or alternatively for disconnecting the power conversion circuitry 506. Disconnecting receive antenna 518 from power conversion circuitry 506 not only suspends charging of device 550, but also changes the “load” as “seen” by the transmitter 404 (FIG. 2).

When multiple receivers 508 are present in a transmitter's near-field, it may be desirable to adjust the loading and unloading of one or more receivers to enable other receivers to more efficiently couple to the transmitter. A receiver 508 may also be cloaked in order to eliminate coupling to other nearby receivers or to reduce loading on nearby transmitters. This “unloading” of a receiver is also known herein as a “cloaking.” Furthermore, this switching between unloading and loading controlled by receiver 508 and detected by transmitter 404 may provide a communication mechanism from receiver 508 to transmitter 404. Additionally, a protocol may be associated with the switching that enables the sending of a message from receiver 508 to transmitter 404. By way of example, a switching speed may be on the order of 100 μsec.

In an exemplary embodiment, communication between the transmitter 404 and the receiver 508 may take place either via an “out-of-band” separate communication channel/antenna or via “in-band” communication that may occur via modulation of the field used for power transfer.

Receive circuitry 510 may further include signaling detector and beacon circuitry 514 used to identify received energy fluctuations that may correspond to informational signaling from the transmitter to the receiver. Furthermore, signaling and beacon circuitry 514 may also be used to detect the transmission of a reduced RF signal energy (i.e., a beacon signal) and to rectify the reduced RF signal energy into a nominal power for awakening either un-powered or power-depleted circuits within receive circuitry 510 in order to configure receive circuitry 510 for wireless charging.

Receive circuitry 510 further includes controller 516 for coordinating the processes of receiver 508 described herein including the control of switching circuitry 512 described herein. It is noted that the controller 516 may also be referred to herein as a processor. Cloaking of receiver 508 may also occur upon the occurrence of other events including detection of an external wired charging source (e.g., wall/USB power) providing charging power to device 550. Controller 516, in addition to controlling the cloaking of the receiver, may also monitor beacon circuitry 514 to determine a beacon state and extract messages sent from the transmitter 404. Controller 516 may also adjust the DC-to-DC converter 522 for improved performance.

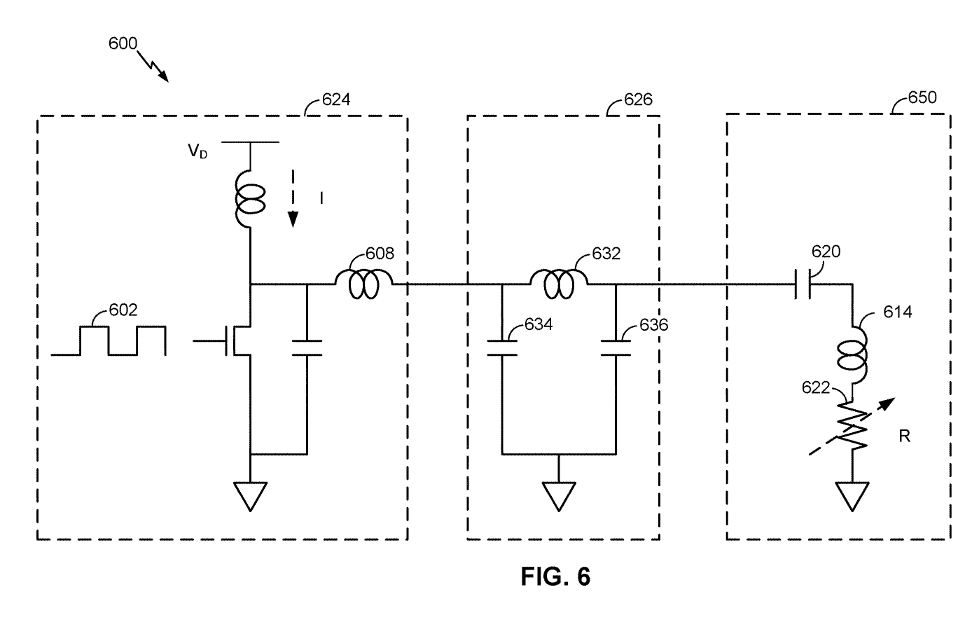

FIG. 6 is a schematic diagram of a portion of transmit circuitry 600 that may be used in the transmit circuitry 406 of FIG. 4. The transmit circuitry 600 may include a driver circuit 624 as described above in FIG. 4. As described above, the driver circuit 624 may be a switching amplifier that may be configured to receive a square wave and output a sine wave to be provided to the transmit circuit 650. In some cases the driver circuit 624 may be referred to as an amplifier circuit. The driver circuit 624 is shown as a class E amplifier, however, any suitable driver circuit 624 may be used in accordance with embodiments of the invention. The driver circuit 624 may be driven by an input signal 602 from an oscillator 423 as shown in FIG. 4. The driver circuit 624 may also be provided with a drive voltage V_{D} that is configured to control the maximum power that may be delivered through a transmit circuit 650. To eliminate or reduce harmonics, the transmit circuitry 600 may include a filter circuit 626. The filter circuit 626 may be a three pole (capacitor 634, inductor 632, and capacitor 636) low pass filter circuit 626.

The signal output by the filter circuit 626 may be provided to a transmit circuit 650 comprising an antenna 614. The transmit circuit 650 may include a series resonant circuit having a capacitance 620 and inductance (e.g., that may be due to the inductance or capacitance of the antenna or to an additional capacitor component) that may resonate at a frequency of the filtered signal provided by the driver circuit 624. The load of the transmit circuit 650 may be represented by the variable resistor 622. The load may be a function of a wireless power receiver 508 that is positioned to receive power from the transmit circuit 650.

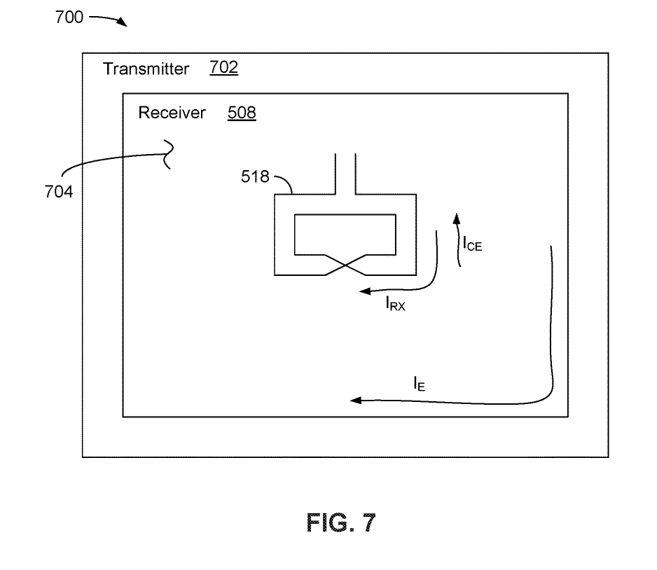

FIG. 7 is a schematic diagram 700 showing an exemplary receiver 508 located on a wireless charging surface 702. The wireless charging surface 702 may comprise a pad, a table, a mat, a lamp, or other structure, and may comprise some or all of the elements described in the transmitter 404 of FIG. 4. In the embodiment shown in FIG. 7, the receiver 508 is smaller in area than the wireless charging surface 702. In the embodiment shown in FIG. 7, the receiver 508 comprises a primary receive antenna 518, and is relatively large compared to the size of the primary receive antenna 518. As used herein, the term “antenna” is used interchangeably with the term “coil,” and, when implemented with a capacitor, may comprise a resonant structure and be referred to as a “resonator.” As shown in FIG. 7, the receiver 508 comprises an enclosure or other metal structure 704 that may be large relative to the size of the primary receive antenna 518. In such an instance, the large metal plate causes a large reactance shift, and also causes a reduction in coupling whereby the flux, referred to as eddy current, I_{E}, induced in the metal structure 704 generates a current, I_{CE}, in the primary receive antenna 518 that opposes the charging current, I_{RX}, in the primary receive antenna 518. The current, I_{CE}, refers to a counter eddy current that is induced in the primary receive antenna 518 by the eddy current, I_{E}. This can cause the electromagnetic coupling from the transmitter 404 to the receiver 508 to be reduced when the receiver 508 is centered on the wireless charging surface 702, since the metal structure 704 covers the maximum area of transmit antenna (not shown in FIG. 7) and thus generates the maximum eddy current, I_{E}, in the metal structure 704 and hence the maximum current, I_{CE}, opposing the charging current, I_{RX}, generated in the primary receive antenna 518.

A transmit antenna (not shown) having a uniform field will show a wider-than-expected range of electromagnetic coupling when a large metallic receiver having a relatively small primary receive antenna is used. This makes receiver and receive antenna design difficult due to a wide voltage range, and/or a receiver that cannot accept charge, or that can accept a reduced charge, at many locations on a wireless charging surface 702. As a result, the overall electromagnetic coupling between the transmit antenna (not shown) and the primary receive antenna 518 is reduced, resulting in a reduction in the voltage available at the receiver 508 (which may result in a voltage too low to be usable) and in an increase in the effective source impedance to a load after the rectifier in the receiver 508, thus possibly reducing available power.

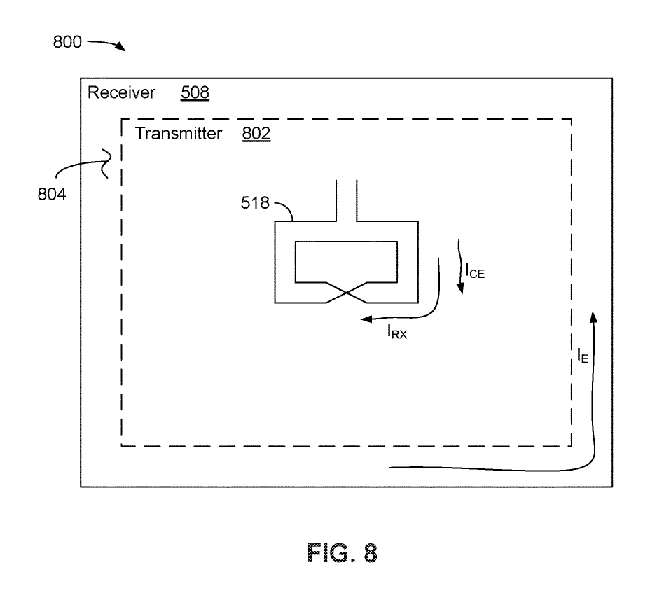

FIG. 8 is a schematic diagram 800 showing an exemplary receiver 508 located on a wireless charging surface 802. The wireless charging surface 802 may comprise a pad, a table, a mat, a lamp, or other structure, and may comprise some or all of the elements described in the transmitter 404 of FIG. 4. In the embodiment shown in FIG. 8, the receiver 508 is larger in area than the wireless charging surface 802 and overhangs the wireless charging surface 802. In the embodiment shown in FIG. 8, the receiver 508 comprises a primary receive antenna 518, and is relatively large compared to the size of the primary receive antenna 518. As used herein, the term “antenna” is used interchangeably with the term “coil,” and, when implemented with a capacitor, may comprise a resonant structure and be referred to as a “resonator.” As shown in FIG. 8, the receiver 508 comprises an enclosure or other metal structure 804 that may be large relative to the size of the primary receive antenna 518.

In such an instance, the large metal plate causes a large reactance shift, and also causes an increase in coupling whereby the flux, referred to as eddy current, I_{E}, induced in the metal structure 804, generates a current, I_{CE}, in the receive antenna 518 that reinforces the charging current, I_{RX}, in the receive antenna. This means that electromagnetic coupling from the transmitter 404 to the receiver 508 is increased when the receiver 508 is centered on the wireless charging surface 802.

When this happens, the eddy current, I_{E}, generated in the metal structure 804 is in the opposite direction from that described in FIG. 7, since the edges of the metal structure 804 extend into a “reverse field” region—the area outside the charge area of the wireless charging surface 802 where the electromagnetic field wraps around the transmit antenna (not shown) in the wireless charging surface 802 and demonstrates a reverse polarity. This induces a current, I_{CE}, in the receive antenna 518 that reinforces the current, I_{RX}, generated by the received field. As a result, the overall electromagnetic coupling between the transmit antenna (not shown) and the primary receive antenna 518 is increased. In some instances, receive voltage may increase beyond the limits that the receiver 508 can handle. This can damage the receiver 508 and/or result in expensive, large and inefficient designs.

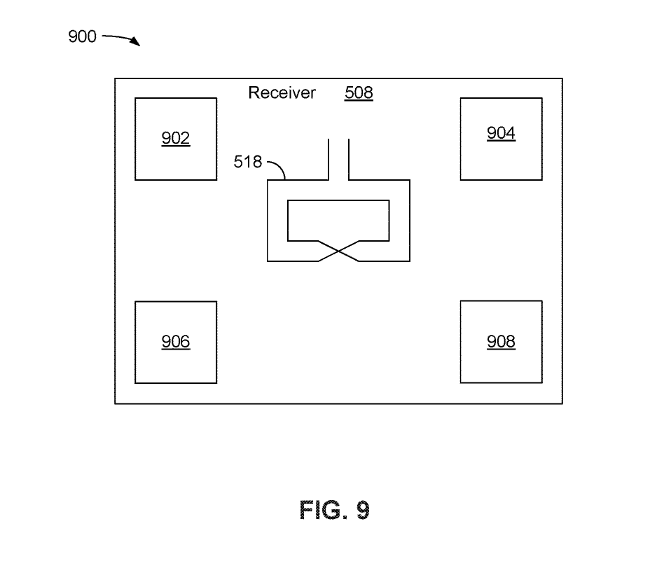

FIG. 9 is a schematic diagram 900 showing an exemplary embodiment of a receiver with a receive antenna. The receiver 508 comprises a primary receive antenna 518. The receiver 508 also comprises exemplary secondary receive antennas 902, 904, 906 and 908. The secondary receive antennas 902, 904, 906 and 908 may also be referred to as “coils” and when coupled with capacitive elements may be configured to create a resonant circuit, may be referred to as “resonators.”

In an exemplary embodiment, the secondary receive antennas 902, 904, 906 and 908 may be located on the periphery of the receiver 508. In an exemplary embodiment, the secondary receive antennas 902, 904, 906 and 908 can be relatively small compared to the primary receive antenna 518, so long as they are located relatively close to the edge of the receiver 508, in the area where the above-mentioned eddy currents are generated. The secondary receive antennas 902, 904, 906 and 908 may be electrically or magnetically coupled to the primary receive antenna 518 via a direct coupling, also referred to as a “direct electrical coupling”; or via a magnetic coupling, such as an inductive coupling, which may also be referred to as a transformer coupling. Although four secondary receive antennas 902, 904, 906 and 908 are shown in FIG. 9, more or fewer secondary receive antennas may be implemented.

Direct Coupling

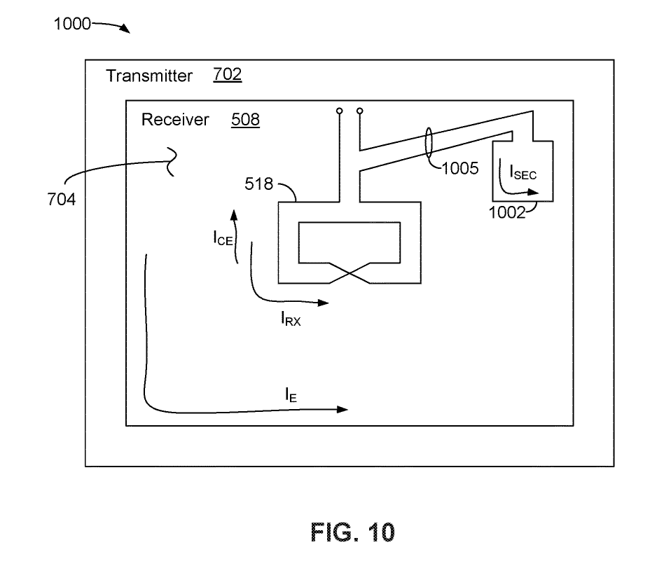

FIG. 10 is a schematic diagram 1000 showing an exemplary embodiment of a receiver with a receive antenna. In the embodiment shown in FIG. 10 a receiver 508 having a metal structure 704 is located on a wireless charging surface 702. The wireless charging surface 702 may comprise a pad, a table, a mat, a lamp, or other structure, and may comprise some or all of the elements described in the transmitter 404 of FIG. 4. In the embodiment shown in FIG. 10, the receiver 508 is smaller than the wireless charging surface 702 and the primary receive antenna 518 is smaller than the metal structure 704. In the example shown in FIG. 10, a secondary receive antenna 1002 is directly coupled to the primary receive antenna 518 via electrically conductive couplings 1005. The electrically conductive couplings 1005 may be wires, or other electrically conductive elements that can also be the same material from which the primary receive antenna 518 and the secondary receive antenna 1002 are formed. Only one secondary receive antenna 1002 is shown in FIG. 10 for simplicity of illustration. More than one secondary antenna may be coupled to the primary receive antenna 518 at various locations, generally toward the periphery of the metal structure 704. In an exemplary embodiment, the electrically conductive couplings 1005 may be a permanent wired connection; or in other cases, the connection between the primary receive antenna 518 and the secondary receive antenna 1002 may be made via a switch or switches, to selectively enable or disable the connection between the primary receive antenna 518 and the secondary receive antenna 1002, depending on whether the voltage and current in the primary receive antenna 518 is higher or lower than desired, based on the effects of the currents mentioned above. For example, a switched connection between the primary receive antenna 518 and the secondary receive antenna 1002 may result in lower resistive losses when magnetic field compensation is not desired.

In the embodiment shown in FIG. 10, the receiver 508 is placed on a wireless charging surface 702 that is larger than the receiver 508. Thus, the eddy current, I_{E}, is in the same direction as the primary receive current, I_{RX}, such that the current, I_{CE} opposes (and thus reduces) the primary receive current, I_{RX}, and the coupling (and voltage) from the transmit antenna (not shown) to the primary receive antenna 518 are reduced.

To compensate for the current I_{CE} reducing the primary receive current, I_{RX}, the primary receive antenna 518 is connected to one or more secondary receive antennas, an exemplary secondary receive antenna 1002 being shown in FIG. 10. Since the secondary receive antenna 1002 is exposed to the same direction field (current, I_{RX}) as the primary receive antenna 518, the secondary receive antenna 1002 generates a current, I_{SEC}, that is in the same direction as the current, I_{RX}, such that the secondary receive antenna 1002 receives power in the same phase as the primary receive antenna 518. This has the effect of increasing the voltage at the primary receive antenna 518, partially or completely compensating for the reduction in electromagnetic coupling caused by the eddy current, I_{E} and the counter eddy current, I_{CE}. An additional effect is that the secondary receive antenna 1002 will tend to partially shield the metal structure 704 and reduce the eddy current as well. Although a single secondary receive antenna 1002 is shown in FIG. 10, typically at least two secondary receive antennas would be implemented.

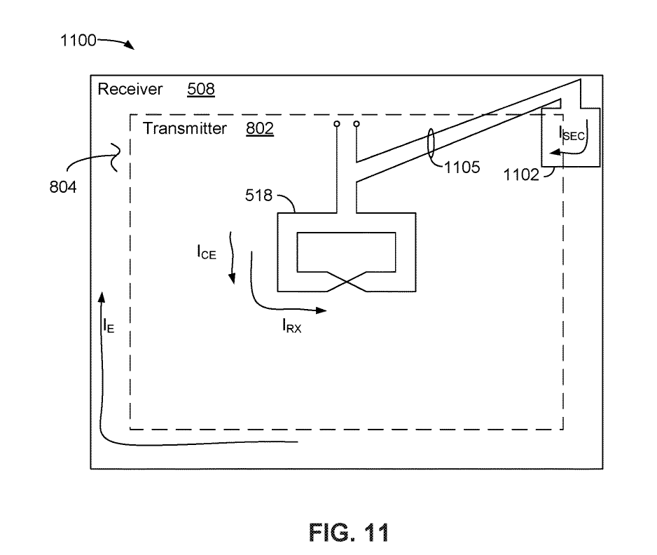

FIG. 11 is a schematic diagram 1100 showing an exemplary embodiment of a receiver with a receive antenna. In the embodiment shown in FIG. 11 a receiver 508 having a metal structure 804 is located on a wireless charging surface 802. The wireless charging surface 802 may comprise a pad, a table, a mat, a lamp, or other structure, and may comprise some or all of the elements described in the transmitter 404 of FIG. 4. In the embodiment shown in FIG. 11, the receiver 508 is larger than the wireless charging surface 802 and the primary receive antenna 518 is smaller than the metal structure 804. In the example shown in FIG. 11, a secondary receive antenna 1102 is directly coupled to the primary receive antenna 518 via electrically conductive couplings 1105. The electrically conductive couplings 1105 may be wires, or other electrically conductive elements that can also be the same material from which the primary receive antenna 518 and the secondary receive antenna 1102 are formed. Only one secondary receive antenna 1102 is shown in FIG. 11 for simplicity of illustration. More than one secondary antenna may be coupled to the primary receive antenna 518 at various locations, generally toward the periphery of the metal structure 804. In an exemplary embodiment, the electrically conductive couplings 1105 may be a permanent wired connection; or in other cases, the connection between the primary receive antenna 518 and the secondary receive antenna 1102 may be made via a switch or switches, depending on whether the voltage and current in the primary receive antenna 518 is higher or lower than desired, based on the effects of the currents mentioned above. For example, a switched connection between the primary receive antenna 518 and the secondary receive antenna 1102 may result in lower resistive losses when magnetic field compensation is not needed.

In the embodiment shown in FIG. 11, the receiver 508 is placed on a wireless charging surface 802 that is smaller than the receiver 508. Thus, the eddy current, I_{E}, is in the direction opposing the direction of the primary receive current, I_{RX}, such that in this exemplary embodiment, the current, I_{CE}, reinforces (and thus increases) the primary receive current, I_{RX}, and the coupling (and voltage) from the transmit antenna (not shown) to the primary receive antenna 518 are increased to the primary receive antenna 518.

To compensate for the current I_{CE} increasing the primary receive current, I_{RX}, the primary receive antenna 518 is connected to one or more secondary receive antennas, an exemplary secondary receive antenna 1102 being shown in FIG. 11. The secondary receive antenna 1102 is exposed to the opposite phase magnetic field as the primary receive antenna 518 since it is located substantially near the outer periphery of the metal structure 804, and a reverse field condition occurs with respect to the embodiment shown in FIG. 10. Thus, in the embodiment shown in FIG. 11, the current, I_{SEC}, induced in the secondary receive antenna 1102 reduces the potential of the primary receive antenna 518, thus reducing the total voltage in the primary receive antenna 518. Although a single secondary receive antenna 1102 is shown in FIG. 11, typically at least two secondary receive antennas would be implemented.

With regard to the embodiments shown in FIG. 10 and FIG. 11, as long as the secondary receive antenna is located approximately where the eddy current is induced in the metal structure 704/804, field cancellation occurs automatically and there is no need to switch the the secondary receive antennas in or out of connection with the primary receive antenna 518. In alternative embodiments, it is possible to obtain greater control of receiver voltage by switching the the secondary receive antennas in or out of connection with the primary receive antenna, based on, for example, a level of coupling, a coupling efficiency, a type or size of transmitter and/or receiver, or other factors.

Inductive Coupling

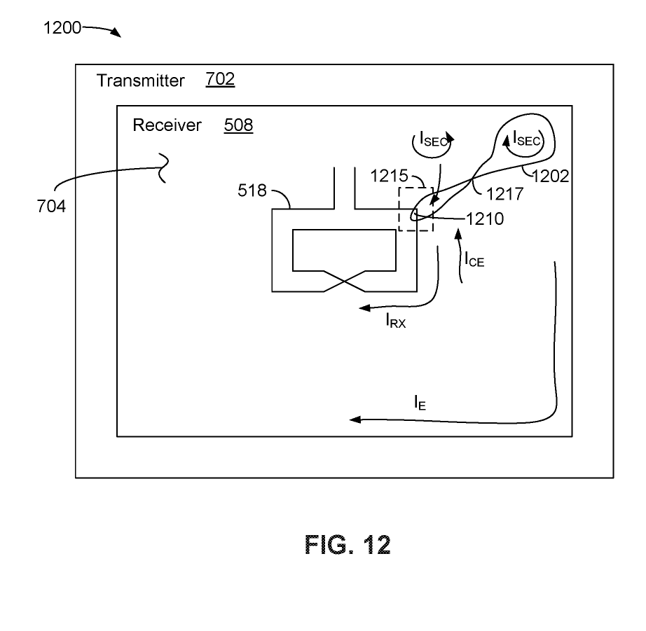

FIG. 12 is a schematic diagram 1200 showing an exemplary embodiment of a receiver with a receive antenna. In the embodiment shown in FIG. 12 a receiver 508 having a metal structure 704 is located on a wireless charging surface 702. The wireless charging surface 702 may comprise a pad, a table, a mat, a lamp, or other structure, and may comprise some or all of the elements described in the transmitter 404 of FIG. 4. In the embodiment shown in FIG. 12, the receiver 508 is smaller than the wireless charging surface 702, and the primary receive antenna 518 is substantially smaller than the metal structure 704. In the example shown in FIG. 12, the secondary receive antenna 1202 is coupled to the primary receive antenna 518 via an inductive coupling 1210, such as a transformer coupling. The inductive coupling 1210 will be described in detail below. Only one secondary receive antenna 1202 is shown in FIG. 12 for simplicity of illustration. More than one secondary receive antenna may be coupled to the primary receive antenna 518.

In an exemplary embodiment, the secondary receive antenna 1202 is used to couple a portion of the flux generated as the eddy current, I_{E}, back to the primary receive antenna 518 via a transformer-like structure. This is similar to the embodiment shown in FIG. 10, but uses the inductive coupling 1210 to eliminate a direct connection (with the consequent resistive losses) between the secondary receive antenna 1202 and the primary receive antenna 518.

In the embodiment shown in FIG. 12, the secondary receive antenna 1202 is coupled to the primary receive antenna 518 at a specific location, shown for example in FIG. 12 as in the region 1215. In the embodiment shown in FIG. 12, a relatively large wireless charging surface 702 and a relatively small primary receive antenna 518 results in a loss of coupling due to the eddy current, I_{E}, causing the current I_{CE} to oppose the primary receive current I_{RX}. The secondary receive antenna 1202 induces a current, I_{SEC}, in the secondary receive antenna 1202 that reinforces the current, I_{RX}, in the primary receive antenna 518. The inductive coupling 1210 comprises a first transformer part and a second transformer part, with the term “part” used to distinguish from the terms “primary” and “secondary” which are used to refer to the inductive coupling established between the primary receive antenna 518 and the secondary receive antennas, such as the secondary receive antenna 1202. The secondary receive antenna 1202 is coupled to the primary receive antenna 518 by the inductive coupling 1210 in such a way that the current, I_{SEC}, in the secondary receive antenna 1202 (and also in the second transformer part (not shown) of the inductive coupling 1210) reinforces the current, I_{RX}, in the primary receive antenna 518 (and also in the first transformer part of the inductive coupling 1210). Thus, the low voltage and low coupling condition that would otherwise be caused by the current, I_{CE}, is ameliorated. Although not shown, the same principles apply to a situation in which the receiver 508 is larger than the wireless charging surface 702 and the primary receive antenna 518 is smaller than the metal structure 704, such as shown in FIG. 11.

The region 1215 indicates an area or region where different types of inductive couplings may be implemented. In physical terms the windings of the first transformer part (not shown) and the second transformer part (not shown) for the inductive coupling 1210 should be wound in opposite directions. This is illustrated as the crossover 1217 shown in FIG. 12. The crossover 1217 illustrates that because a transformer will reverse the phase of a current signal, in order for the current, I_{SEC}, to reinforce the current, I_{RX}, a second reversal via the crossover 1217 ensures that the phase of I_{SEC} and I_{RX} remain the same.

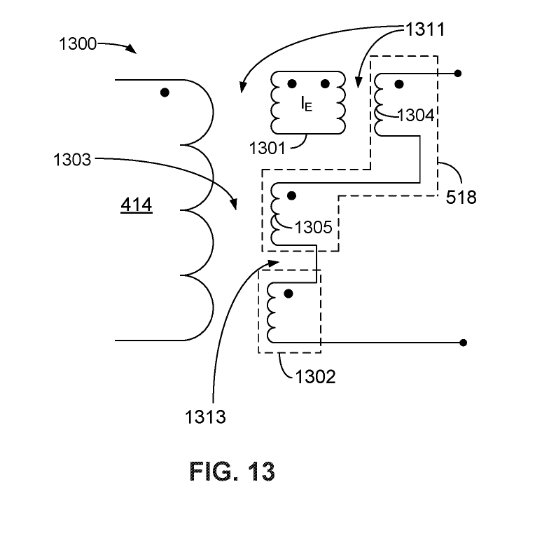

FIG. 13 is a schematic diagram 1300 illustrating coupling mechanisms modeled as transformer structures as a result of the direct coupling shown in FIG. 10 and FIG. 11. The primary transmit antenna 414 is shown on the left hand side of FIG. 13, the eddy current, I_{E}, is shown by the transformer structure 1301, the primary receive antenna 518 is shown as having a first transformer part 1304 and a second transformer part 1305, and the secondary receive antenna is represented by the transformer structure 1302. Obtaining the desired coupling generally comprises adjusting, or controlling, at least two coupling mechanisms. A first coupling mechanism is the coupling between the primary transmit antenna 414 and the primary receive antenna 518. This coupling mechanism is shown in FIG. 13 as coupling 1303. A second coupling mechanism is the coupling between the primary transmit antenna 414, and the eddy current, I_{E}, induced in the metal structure and represented by the transformer structure 1301, and the coupling between the eddy current, I_{E}, represented by the transformer structure 1301 and the primary receive antenna 518. This coupling mechanism is collectively shown in FIG. 13 as coupling 1311. A third coupling mechanism is the coupling between the primary receive antenna 518 and a secondary receive antenna 1302, shown as the lower transformer structure in FIG. 13. This coupling mechanism is shown in FIG. 13 as coupling 1313. The coupling mechanism 1311 tends to increase or decrease the coupling of the coupling mechanism 1303, depending on the relative sizes of the transmit and receive antennas. It is desirable to choose transformer coupling constants (K) such that the influence of the coupling mechanism 1311 (e.g., the coupling between the primary transmit antenna 414, and the eddy current, I_{E}, and the coupling between the eddy current, I_{E}, and the primary receive antenna 518, shown as the upper transformer structure in FIG. 13) is negated by the influence of the coupling mechanism 1313 (e.g., the coupling between the primary receive antenna 518 and a secondary receive antenna 1302, shown as the lower transformer structure in FIG. 13). The polarity indicators (dots) on the transformer structures denote the coupling directions. Since each transformation (i.e., each transformer coupling) causes an inversion of phase, transformer polarity should be considered. In the direct coupled embodiment shown in FIG. 10 and FIG. 11, all the polarities are “standard” where the dot is located on top of both the first transformer part and the second transformer part. FIG. 13 represents the embodiment shown in FIG. 7 where the receiver is smaller than the transmitter. To represent the embodiment shown in FIG. 8, where the receiver is larger than the transmitter, the polarity marks on the left side of the transformer structure 1301, (I_{E}) and the transformer representing the secondary receive antenna 1302 transformers would be reversed.

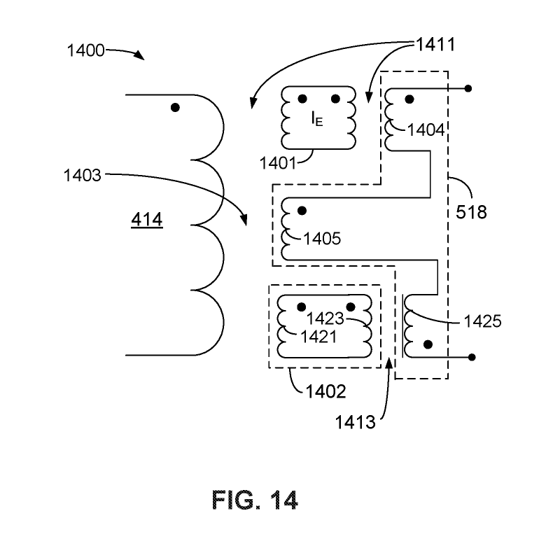

FIG. 14 is a schematic diagram 1400 illustrating coupling mechanisms modeled as transformer structures as a result of the inductive coupling shown in FIG. 12. The primary transmit antenna 414 is shown on the left hand side of FIG. 14, the eddy current, I_{E}, is shown by the transformer structure 1401, the primary receive antenna 518 is shown as having a first transformer part 1404 and a second transformer part 1405, and the secondary receive antenna is represented by the transformer structure 1402. Obtaining the desired coupling generally comprises adjusting, or controlling, at least two coupling mechanisms. A first coupling mechanism is the coupling between the primary transmit antenna 414 and the primary receive antenna 518. This coupling mechanism is shown in FIG. 14 as coupling 1403. A second coupling mechanism is the coupling between the primary transmit antenna 414, and the eddy current, I_{E}, induced in the metal structure, and represented by the transformer structure 1401, and the coupling between the eddy current, I_{E}, represented by the transformer structure 1401, and the primary receive antenna 518. This coupling mechanism is collectively shown in FIG. 14 as coupling 1411. A third coupling mechanism is the coupling between the primary receive antenna 518 and a secondary receive antenna 1402, shown as the lower transformer structure in FIG. 14. This coupling mechanism is shown in FIG. 14 as coupling 1413. In the exemplary embodiment shown in FIG. 14, the coupling between the primary receive antenna 518 and the secondary receive antenna 1402 is an inductive coupling. Therefore, the secondary receive antenna 1402 is illustrated as a transformer having a first transformer part 1421 and a second transformer part 1423, and the primary receive antenna 518 is shown as having an additional transformer part 1425. The coupling mechanism 1411 tends to increase or decrease the coupling of the coupling mechanism 1403, depending on the relative sizes of the transmit and receive antennas. It is desirable to choose transformer coupling constants (K) such that the influence of the coupling mechanism 1411 (e.g., the coupling between the primary transmit antenna 414, and the eddy current, I_{E}, and the coupling between the eddy current, I_{E}, and the primary receive antenna 518, shown as the upper transformer structure in FIG. 14) is negated by the influence of the coupling mechanism 1413 (e.g., the coupling between the primary receive antenna 518 and a secondary receive antenna 1402, shown as the bottom transformer structure in FIG. 14).

The polarity indicators (dots) on the transformer structures denote the coupling directions. Since each transformation (i.e., each transformer coupling) causes an inversion of phase, transformer polarity should be considered. In the inductive coupled embodiment shown in FIG. 12, the polarity of one of the first transformer part or the second transformer part of the coupling 1413 between secondary receive antenna 1402 and the primary receive antenna 518 is inverted (the dot on the right-hand additional transformer part 1425 is on the bottom) since phase inversion is used to cancel the contribution from the eddy current coupling 1411. In physical terms this means that the windings of the first transformer part and the second transformer part for each of the transformers associated with the couplings 1411 and 1413 should be wound in opposite directions. This is illustrated as the crossover 1217 shown in FIG. 12. The polarity of the transformer couplings change when the relative sizes of the transmitter and receiver change. In embodiments where the receiver is smaller than the transmitter the dots denoting the transformer polarity on the left side of the transformer representing the secondary receive antenna 1402 and the transformer representing the eddy current, should be on the top as shown in FIG. 14. In embodiments where the receiver is larger than the transmitter, the dots denoting the transformer polarity on the left side of the transformer representing the secondary receive antenna 1402 and the transformer representing the eddy current, I_{E}, should be on the bottom.

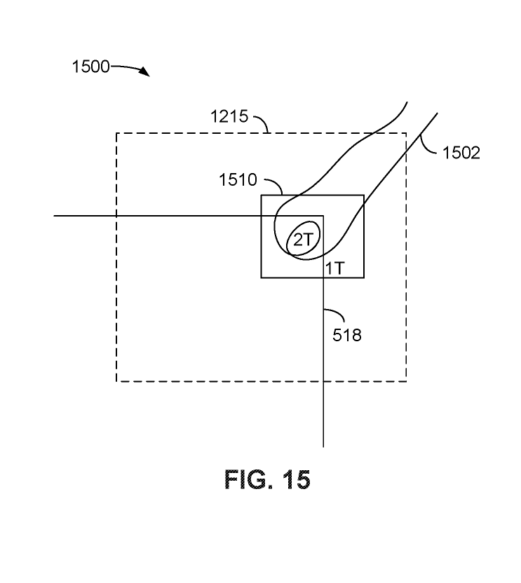

FIG. 15 is a schematic diagram 1500 illustrating an exemplary embodiment of an inductive coupling between a primary receive antenna 518 and a secondary receive antenna 1502. There are a variety of ways of adjusting the coupling between the primary receive antenna 518 and a secondary receive antenna 1502. In the exemplary embodiment shown in FIG. 15, the region 1215 comprises a primary receive antenna 518 and a secondary receive antenna 1502 coupled via an inductive coupling 1510 having a ratio of one turn (1T) to two turns (2T) between the primary receive antenna 518 and a secondary receive antenna 1502. However, in an alternative embodiment, other ratios are possible, and the primary receive antenna 518 may have more turns than the secondary receive antenna 1502.

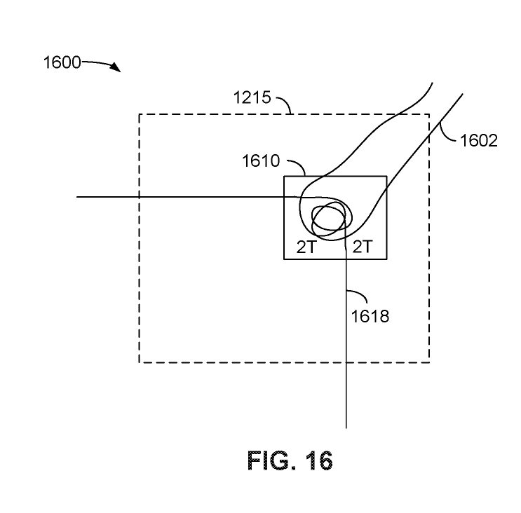

FIG. 16 is a schematic diagram 1600 illustrating an exemplary embodiment of an inductive coupling between a primary receive antenna 518 and a secondary receive antenna 1602. In the embodiment shown in FIG. 16, the number of turns on the primary receive antenna 518 is increased from that shown in FIG. 15. In the exemplary embodiment shown in FIG. 16, the region 1215 comprises a primary receive antenna 1618 and a secondary receive antenna 1602 coupled via an inductive coupling 1610 having a ratio of two turns (2T) to two turns (2T) between the primary receive antenna 1618 and a secondary receive antenna 1602. In general the more turns, the higher the coupling coefficient K. The ratio of primary to secondary turns can also be used to adjust the relative impedances of both sides of the inductive coupling 1610 to achieve a better match between source and load.

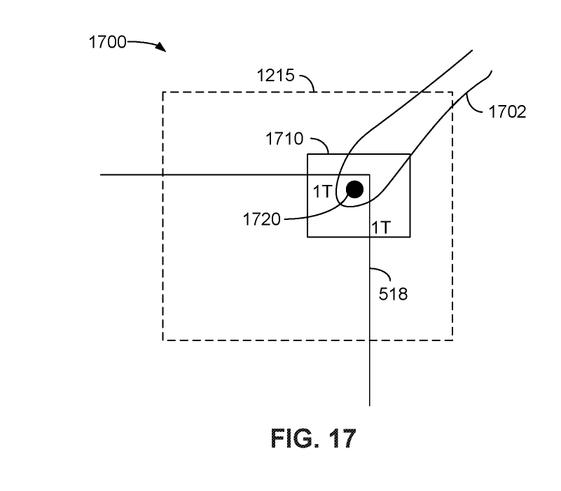

FIG. 17 is a schematic diagram 1700 illustrating an exemplary embodiment of an inductive coupling between a primary receive antenna 518 and a secondary receive antenna 1702. In the embodiment shown in FIG. 17, a high-μ material 1720 (e.g., a ferrite core) can be implemented in the inductive coupling 1710 and used to increase the electromagnetic coupling between the primary receive antenna 518 and the secondary receive antenna 1702. In the embodiment shown in FIG. 17, the region 1215 comprises a primary receive antenna 518 and a secondary receive antenna 1702 coupled via an inductive coupling 1710 having a ratio of one turn (1T) to one turn (1T) between the primary receive antenna 518 and a secondary receive antenna 1702. However, the high-μ material 1720 operates to increase the coupling coefficient, K, without increasing wire length and thus without increasing resistance.

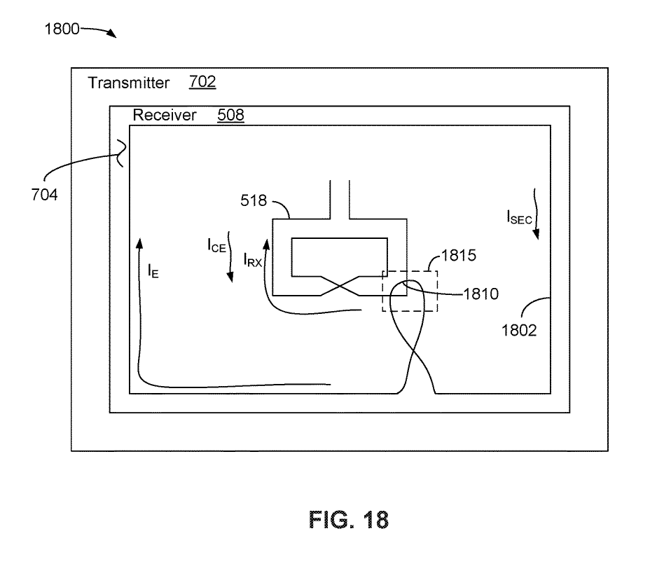

FIG. 18 is a schematic diagram 1800 illustrating an exemplary embodiment of an alternative exemplary embodiment of a receiver with a receive antenna. In the embodiment shown in FIG. 18 a receiver 508 having a metal structure 704 is located on a wireless charging surface 702. The wireless charging surface 702 may comprise a pad, a table, a mat, a lamp, or other structure, and may comprise some or all of the elements described in the transmitter 404 of FIG. 4. In the embodiment shown in FIG. 18, the receiver 508 is smaller than the wireless charging surface 702 and the primary receive antenna 518 is substantially smaller than the metal structure 704. In the example shown in FIG. 18, a secondary receive antenna 1802 is coupled to the primary receive antenna 518 via an inductive coupling 1810 in the region 1815. Alternatively, the secondary receive antenna 1802 may be coupled to the primary receive antenna 518 via a direct connection as described above.

In an exemplary embodiment, the secondary receive antenna 1802 is substantially larger than the above-described secondary receive antennas, and in an exemplary embodiment, may be implemented as a single secondary receive antenna 1802. In this embodiment, the secondary receive antenna 1802 is sufficiently large such that it substantially covers the area on the metal structure 704 where the eddy current, I_{E}, would normally be induced, and is used to capture the field generated by the eddy current, I_{E}. The secondary current, I_{SEC}, generated in the secondary receive antenna 1802 occurs in the same direction as the eddy current, I_{E}, and is coupled to the primary receive antenna 518 to enhance the primary receive current, I_{RX}, as described above.

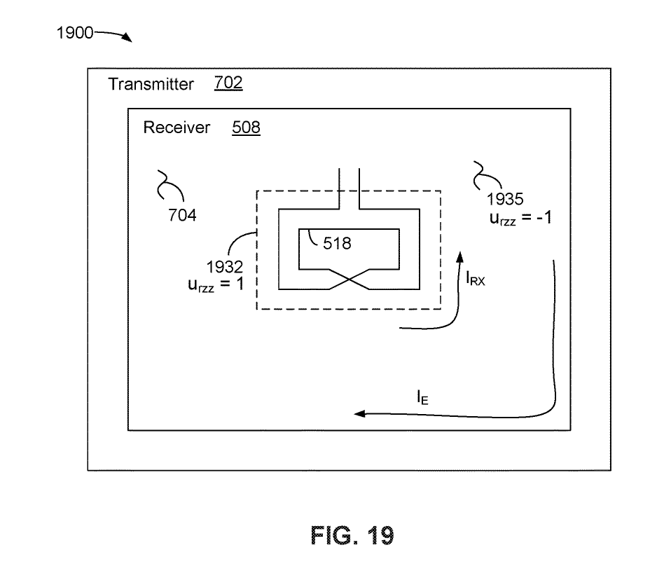

FIG. 19 is a is a schematic diagram 1900 showing an alternative exemplary embodiment of a receiver configured to reduce eddy current. In the embodiment shown in FIG. 19 a receiver 508 having a metal structure 704 is located on a wireless charging surface 702. The wireless charging surface 702 may comprise a pad, a table, a mat, a lamp, or other structure, and may comprise some or all of the elements described in the transmitter 404 of FIG. 4. In the embodiment shown in FIG. 19, the receiver 508 is smaller than the wireless charging surface 702 and the primary receive antenna 518 is smaller than the metal structure 704. In the embodiment shown in FIG. 19, magnetic material is used to reduce eddy current in the metal structure 704. In an exemplary embodiment, the receiver 508 comprises a magnetic material 1932 located in the vicinity of the primary receive antenna 518, and a magnetic material 1935 covering the entire surface of the metal structure 704. In an exemplary embodiment, the magnetic material 1932 may have an anisotropic property of (ur_{zz}=1). When a transmitting magnetic field (not shown) is incident perpendicular to the receiver 508 and the metal structure 704, the eddy current, I_{E}, on both the receiver 508 and metal structure 704 flows in the same direction. However, if a magnetic material 1935 with an anisotropic property (ur_{zz}=−1) is thin coated on the metal structure 704, then the eddy current, I_{E}, flows in the opposite direction relative to the current I_{RX} flowing in the same direction as the current in a transmit antenna (not shown). There is an overhang of positive ferrite covering the receive antenna and this overhang can prevent a reduction in the receive current I_{RX} from occurring as a result of the opposite direction of the eddy current I_{E}.

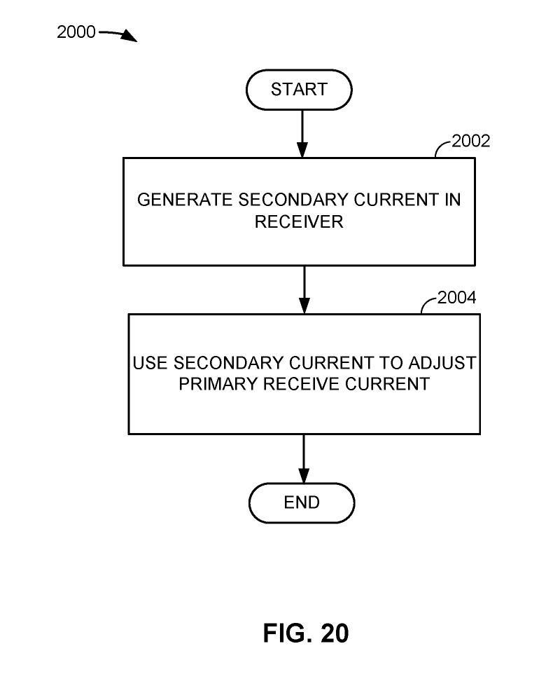

FIG. 20 is a flowchart 2000 illustrating an exemplary embodiment of a method for adjusting a response of a primary receive antenna. The blocks in the method 2000 can be performed in or out of the order shown.

In block 2002, in an exemplary embodiment, a secondary current, I_{SEC}, is generated in a receiver.

In block 2004, the secondary current, I_{SEC}, is used to adjust a primary receive current, I_{RX}. The secondary current, I_{SEC} may be generated in a direction that opposes the primary receive current, I_{RX}, or that enhances the primary receive current, I_{RX}.

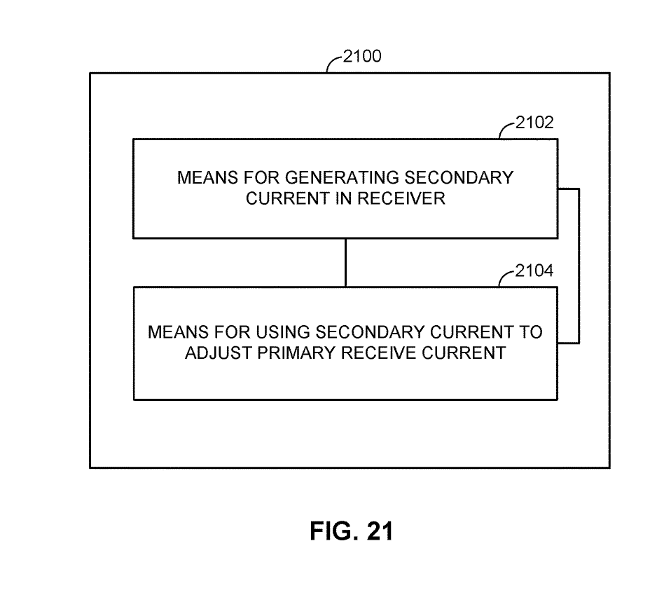

FIG. 21 is a functional block diagram of an apparatus 2100 for for adjusting a response of a primary receive antenna.

The apparatus 2100 comprises means 2102 for generating a secondary current, I_{SEC}, in a receiver. In certain embodiments, the means 2102 for generating a secondary current, I_{SEC}, in a receiver can be configured to perform one or more of the function described in operation block 2002 of method 2000 (FIG. 20). In an exemplary embodiment, the means 2002 for generating a secondary current, I_{SEC}, in a receiver may comprise the structure shown in any of FIG. 9 through FIG. 19.

The apparatus 2100 further comprises means 2104 for using the secondary current, I_{SEC}, to adjust a primary receive current, I_{RX}. The secondary current, I_{SEC} may be generated in a direction that opposes the primary receive current, I_{RX}, or that enhances the primary receive current, I_{RX}. In certain embodiments, the means 2104 for using the secondary current, I_{SEC}, to adjust a primary receive current, I_{RX} can be configured to perform one or more of the function described in operation block 2004 of method 2000 (FIG. 20). In an exemplary embodiment, the means 2004 for using the secondary current, I_{SEC}, to adjust a primary receive current, I_{RX} may comprise the structure shown in any of FIG. 9 through FIG. 19.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

In view of the disclosure above, one of ordinary skill in programming is able to write computer code or identify appropriate hardware and/or circuits to implement the disclosed invention without difficulty based on the flow charts and associated description in this specification, for example. Therefore, disclosure of a particular set of program code instructions or detailed hardware devices is not considered necessary for an adequate understanding of how to make and use the invention. The inventive functionality of the claimed computer implemented processes is explained in more detail in the above description and in conjunction with the FIGS. which may illustrate various process flows.

In one or more exemplary aspects, the functions described may be implemented in hardware, software, firmware, or any combination thereof. If implemented in software, the functions may be stored on or transmitted as one or more instructions or code on a computer-readable medium. Computer-readable media include both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer.

Also, any connection is properly termed a computer-readable medium. For example, if the software is transmitted from a website, server, or other remote source using a coaxial cable, fiber optic cable, twisted pair, digital subscriber line (“DSL”), or wireless technologies such as infrared, radio, and microwave, then the coaxial cable, fiber optic cable, twisted pair, DSL, or wireless technologies such as infrared, radio, and microwave are included in the definition of medium.

Disk and disc, as used herein, includes compact disc (“CD”), laser disc, optical disc, digital versatile disc (“DVD”), floppy disk and Blu-Ray disc where disks usually reproduce data magnetically, while discs reproduce data optically with lasers. Combinations of the above should also be included within the scope of computer-readable media.

Although selected aspects have been illustrated and described in detail, it will be understood that various substitutions and alterations may be made therein without departing from the spirit and scope of the present invention, as defined by the following claims.

What is claimed is:

1. A wireless power receiver, comprising:
a first receive coil configured to generate electrical current in response to a first external magnetic field generated by a transmit coil; and
a second receive coil configured to generate electrical current in response to a second magnetic field generated by eddy currents induced in a metal portion of the wireless power receiver in response to the first external magnetic field.

2. The wireless power receiver of claim 1, wherein the second receive coil adjusts a level of current in the first receive coil.

3. The wireless power receiver of claim 1, wherein the first receive coil is positioned such that the direction of electrical current in the first receive coil is the same as the direction of the electrical current in the second receive coil when a phase of the first external generated magnetic field is the same at both the first receive coil and the second receive coil and that the direction of the electrical current in the first receive coil is opposite of the direction of the electrical current in the second receive coil when the phase of the first external generated magnetic field is substantially opposite at the first receive coil as compared to the second receive coil.

4. The wireless power receiver of claim 1, wherein the electrical current in the second receive coil compensates for a loss in coupling between the transmit coil and the wireless power receiver due to the second magnetic field generated by the eddy currents.

5. The wireless power receiver of claim 1, wherein the electrical current in the second receive coil compensates for an increase in coupling between the transmit coil and the wireless power receiver due to the second magnetic field generated by the eddy currents.

6. The wireless power receiver of claim 1, wherein a magnetic coupling between the first receive coil and the second receive coil alters a magnetic coupling between the first receive coil and the transmit coil.

7. The wireless power receiver of claim 1, wherein:
a first magnetic coupling is established between the transmit coil and the first receive coil;
a second magnetic coupling is established between the transmit coil and the metal portion of the wireless power receiver;
a third magnetic coupling is established between the first receive coil and the second receive coil; and
wherein the third magnetic coupling at least partially negates an effect of the second magnetic coupling.

8. The wireless power receiver of claim 1, wherein the second receive coil is positioned in a region towards an outer portion of the wireless power receiver where the eddy currents are configured to be generated in one or more metal portions of the wireless power receiver that are outside of an an area defined by the first receive coil.

9. The wireless power receiver of claim 1, wherein the second receive coil is directly electrically connected via a wired connection to the first receive coil.

10. The wireless power receiver of claim 9, wherein the second receive coil is electrically connected via a switch to the first receive coil, the switch responsive to a controller configured to enable and disable the second receive coil based on a coupling between the transmit coil and the wireless power receiver.

11. The wireless power receiver of claim 1, wherein the second receive coil is positioned to be inductively coupled with the first receive coil.

12. The wireless power receiver of claim 11, wherein inductively coupled comprises a transformer coupling.

13. The wireless power receiver of claim 11, further comprising a transformer formed from a portion of the first receive coil and a portion of the second receive coil.

14. The wireless power receiver of claim 12, wherein the transformer coupling comprises a ratio of a first number of turns of the first receive coil and a second number of turns of the second receive coil.

15. The wireless power receiver of claim 12, wherein the transformer coupling comprises a high-μ material between a first number of turns of the first receive coil and a second number of turns of the second receive coil.

16. A method for adjusting a level of magnetic coupling in a wireless power receiver, comprising:
generating a first electrical current in a first receive coil in response to a first external magnetic field generated by a transmit coil; and
generating a second electrical current in a second receive coil in response to a second magnetic field generated by eddy currents induced in a metal portion of a wireless power receiver in response to the first external magnetic field.

17. The method of claim 16, wherein the direction of the first electrical current is the same as the direction of the second electrical current when a phase of the first external generated magnetic field is the same as the phase of the second generated magnetic field and the direction of the first electrical current is opposite of the direction of the second electrical current when the phase of the first external generated field is substantially opposite the phase of the second generated magnetic field.

18. The method of claim 16, wherein the second electrical current compensates for a loss in coupling between the transmit coil and the wireless power receiver due to the second magnetic field generated by the eddy currents.

19. The method of claim 16, wherein the second electrical current compensates for an increase in coupling between the transmit coil and the wireless power receiver due to the second magnetic field generated by the eddy currents.

20. The method of claim 16, further comprising altering a magnetic coupling between the first receive coil and the transmit coil.

21. The method of claim 16, further comprising:
establishing a first magnetic coupling between the transmit coil and the first receive coil;
establishing a second magnetic coupling between the transmit coil and the metal portion of the wireless power receiver;
establishing a third magnetic coupling between the first receive coil and the second receive coil; and
wherein the third magnetic coupling at least partially negates an effect of the second magnetic coupling.

22. The method of claim 16, further comprising directly electrically coupling the first receive coil to the second receive coil.

23. The method of claim 22, further comprising switchably coupling the second receive coil to the first receive coil based on a coupling between the transmit coil and the wireless power receiver.

24. The method of claim 16, further comprising inductively coupling the first receive coil to the second receive coil.

25. The method of claim 24, wherein inductively coupling the first receive coil to the second receive coil comprises a transformer coupling.

26. The method of claim 25, wherein the transformer coupling comprises a ratio of a first number of turns of the first receive coil and a second number of turns of the second receive coil.

27. The method of claim 25, wherein the transformer coupling comprises a high-μ material between a first number of turns of the first receive coil and a second number of turns of the second receive coil.

28. A device for adjusting a level of magnetic coupling in a wireless power receiver, comprising:
first means for generating electrical current in response to a first external magnetic field generated by a transmit coil; and
second means for generating electrical current in response to a second magnetic field generated by eddy currents induced in a metal portion of the wireless power receiver in response to the first external magnetic field.

29. A wireless power receiver apparatus, comprising:
a first receive coil;
a receive circuit electrically coupled to the first receive coil and configured to power or charge a load in response to receiving and controlling current generated in the first receive coil in the presence of a first external magnetic field; and
a second receive coil positioned in a region towards an outer portion of the apparatus where one or more eddy currents are configured to be generated in one or more metal portions of the apparatus that are outside of an an area defined by the first receive coil.

30. The apparatus of claim 29, wherein the one or more eddy currents generate one or more secondary currents in the second receive coil, the one or more secondary currents configured to alter the current generated in the first receive coil.

31. The apparatus of claim 29, wherein the second receive coil is positioned such that the direction of current in the first receive coil is the same as the direction of the current in the second receive coil when a phase of the first external magnetic field is the same at both the first receive coil and the second receive coil and that the direction of the current in the first receive coil is opposite of the direction of the current in the second receive coil when the phase of the first external magnetic field is substantially opposite at the first receive coil as compared to the second receive coil.

32. The apparatus of claim 29, wherein the current in the second receive coil compensates for a loss in coupling between a transmit coil and the wireless power receiver apparatus due to a magnetic field generated by the eddy currents.

33. The apparatus of claim 29, wherein the current in the second receive coil compensates for an increase in coupling between a transmit coil and the wireless power receiver apparatus due to a magnetic field generated by the eddy currents.

34. The apparatus of claim 29, wherein a magnetic coupling between the first receive coil and the second receive coil alters a magnetic coupling between the first receive coil and a transmit coil.

35. The apparatus of claim 29, wherein:
a first magnetic coupling is established between a transmit coil and the first receive coil;
a second magnetic coupling is established between the transmit coil and the metal portion of the wireless power receiver apparatus;
a third magnetic coupling is established between the first receive coil and the second receive coil; and
wherein the third magnetic coupling at least partially negates an effect of the second magnetic coupling.

36. The apparatus of claim 29, wherein the second receive coil is directly electrically connected via a wired connection to the first receive coil.

37. The apparatus of claim 36, wherein the second receive coil is electrically connected via a switch to the first receive coil, the switch responsive to a controller configured to enable and disable the second receive coil based on a coupling between a transmit coil and the wireless power receiver apparatus.

38. The apparatus of claim 29, wherein the second coil is positioned to be inductively coupled with the first receive coil.

39. The apparatus of claim 38, further comprising a transformer formed from a portion of the first receive coil and a portion of the second receive coil.

40. The apparatus of claim 39, wherein the transformer comprises a ratio of a first number of turns of the first receive coil and a second number of turns of the second receive coil.
